(19) United States
(12) Patent Application Publication
(10) Pub. No.: US 2005/0253367 A1
(43) Pub. Date: Nov. 17, 2005

(54) Gas bag for a vehicle occupant restraint system

(75) Inventor: Juergen Heigl, Boebingen (DE)

Correspondence Address: TAROLLI, SUNDHEIM, COVELL, & TUMMINO L.L.P.;1111 LEADER BLDG., 526 SUPERIOR AVENUE, CLEVELAND, OH, 44114-1400, US

(73) Assignee: TRW Automotive GmbH

(21) Appl. No.: 11/127,539

(22) Filed: May 12, 2005

(30) Foreign Application Priority Data
May 13, 2004 (DE) 10 2004 023 904.5

(51) Int. Cl. B60R 21/22

(52) U.S. Cl. 280/730.2

(57) ABSTRACT

A gas bag, in particular a side gas bag for a vehicle occupant restraint system has a first and a second planar side wall, connected with each other, consisting of a textile fabric with warp threads and weft threads, which at least partially delimit at lest one inflatable chamber laterally. Between the side walls at least one elongated dividing wall is provided, running continuously over a majority of the length of the side gas bag and delimiting a gas duct which directs inflowing gas into the inflatable chamber. The dividing wall is formed by threads which leave the textile fabric composite of one of the side walls in the direction of the opposite side wall and run over a predetermined length inside the side gas bag. The dividing wall has at least one overflow section with a higher gas-permeability than that of the remaining dividing wall, which forms a flow path from the gas duct to an adjoining inflatable chamber.

### FIELD OF THE INVENTION

The invention relates to a gas bag, in particular a side gas bag for a vehicle occupant restraint system.

### BACKGROUND OF THE INVENTION

Side gas bags having a large area cover entire side window areas of a vehicle. In order to nevertheless achieve a uniform and rapid inflation, frequently gas ducts are provided via which the gas which is used for inflating is directed from a gas generator to individual inflatable chambers of the gas bag. The gas duct should have as large a volume as possible but nevertheless take up as little storage space as possible and of course it has to be as simple and favourably priced to manufacture as possible.

It is an object of the invention to provide a gas bag with such a gas duct.

### BRIEF SUMMARY OF THE INVENTION

The gas bag for a vehicle occupant restraint system has a first and a second planar side wall, connected with each other, consisting of a woven fabric with warp- and weft threads, which at least partially laterally delimit at least one inflatable chamber Between the side walls at least one elongated dividing wall is provided, running continuously over a majority of the length of the side gas bag and delimiting a gas duct which directs inflowing gas into the inflatable chambers, the dividing wall being formed by threads which leave the woven fabric composite of one of the side walls in the direction of the opposite side wall and run over a predetermined length in the interior of the side gas bag. The dividing wall has at least one overflow section with a higher gas-permeability than that of the remaining dividing wall, the overflow section forming a flow path from the gas duct to an adjoining inflatable chamber. In the region of the dividing wall the thread sections are preferably interwoven with each other, so that the dividing wall is constructed as a textile fabric. The threads can, however, also run through the gas bag without weaving.

The dividing wall can be woven directly in the production of the side gas bag in one piece with the remaining side gas bag or sections of the side gas bag, e.g. by a known weaving method. As the two side walls assume a certain distance from each other in the region of the dividing wall in the inflated gas bag, i.e. do not lie directly against each other, the gas duct has a relatively large volume.

Several overflow sections can be provided, e.g. one or more per inflatable chamber.

Outside the overflow section, the dividing wall is preferably constructed so as to be largely gas-tight, so that the gas arrives substantially only through the overflow section or sections from the gas duct into the inflatable chambers. The gas-tightness of the dividing wall can be achieved for example in that the dividing wall and/or the threads forming the dividing wall are provided with a coating which reduces the gas-permeability of the dividing wall.

In order to achieve a high gas-permeability, for example the overflow section can have a lower thread density than the remaining dividing wall. This is also to be understood to relate to embodiments in which the dividing wall has at least one gap in the overflow section. It is possible to provide several gaps in the overflow section and to provide a dividing wall web between each pair of gaps. This arrangement offers a good gas-permeability, whilst through the webs the shape of the side gas bag and of the gas duct is maintained when pressurized gas flows through the gas duct.

The different gas-tightness can also be achieved or assisted through the omission of a coating in the region of the overflow section.

In a preferred embodiment of the invention, for the formation of the dividing wall, warp threads, weft threads and/or pile threads of the first side wall emerge from the woven fabric composite of the first side wall, run to the second side wall and enter into the woven fabric composite of the second side wall.

The thread density of the dividing wall is preferably relatively high. It is possible to use half to two thirds of the warp and/or weft threads of a side wall for the formation of the dividing wall. With a thread density of 235 thread/dm, this would correspond to a thread density of approximately 120 to 180 thread/dm in the dividing wall. Instead of the warp or weft threads or additionally thereto, pile threads, e.g. with a similar thread density, can also be used.

For example, two dividing walls can be provided which, viewed in cross-section, form the shape of an X.

According to another embodiment of the invention, four dividing walls are provided which delimit a gas duct which is diamond-shaped in cross-section. In this embodiment, the inherent stability of the gas duct is very high.

In both cases, the thread density of the first side wall always corresponds to the thread density of the second side wall, i.e. equal numbers of threads are leaving the first and second side walls and entering into the respective other side wall.

Preferably, the gas duct runs in the immediate vicinity of, and parallel to an upper edge of the side gas bag. This construction has in fact proved to be successful especially in curtain-shaped side gas bags.

The gas duct is advantageously directly in flow connection with a gas generator, so that the compressed gas generated thereby flows directly into the gas duct and from there into the inflatable chambers.

### BRIEF DESCRIPTION OF THE DRAWINGS

FIG. 1 shows a perspective view of a portion of a side gas bag according to the invention in a first embodiment with two dividing walls;

FIG. 2 shows a perspective illustration of a portion of the side gas bag of FIG. 1 in the region of an overflow section;

FIG. 3 shows a perspective illustration of a portion of a side gas bag according to the invention in an embodiment with four dividing walls; and

FIG. 4 shows a section through a coated thread of a dividing wall of a gas bag from one of the preceding Figures.

### DETAILED DESCRIPTION OF PREFERRED EMBODIMENTS

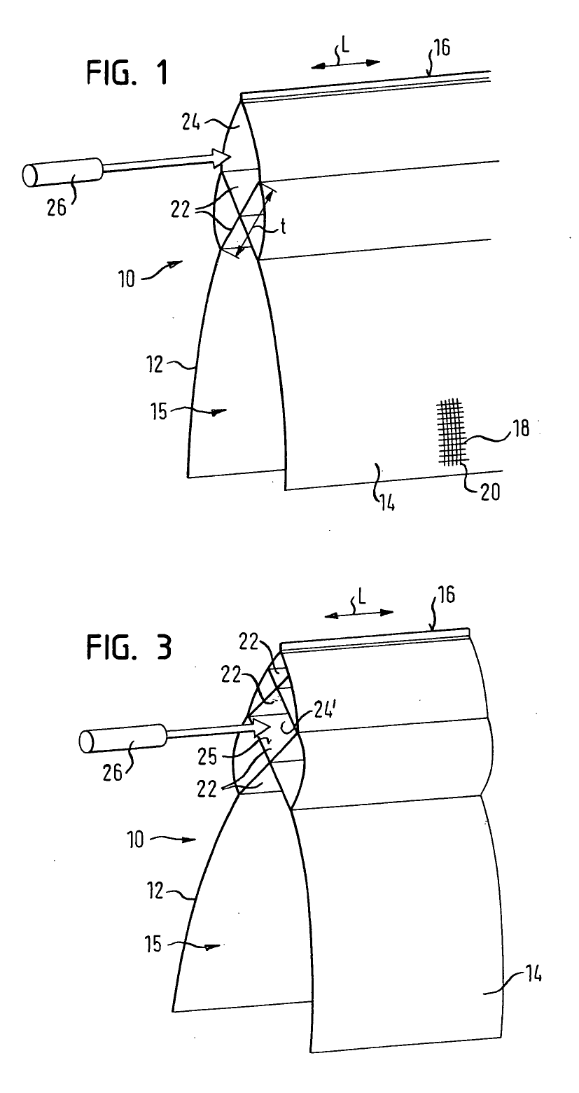

FIG. 1 shows a side gas bag 10 which can be used for example as a curtain-like gas bag in a vehicle covering one or more side windows there.

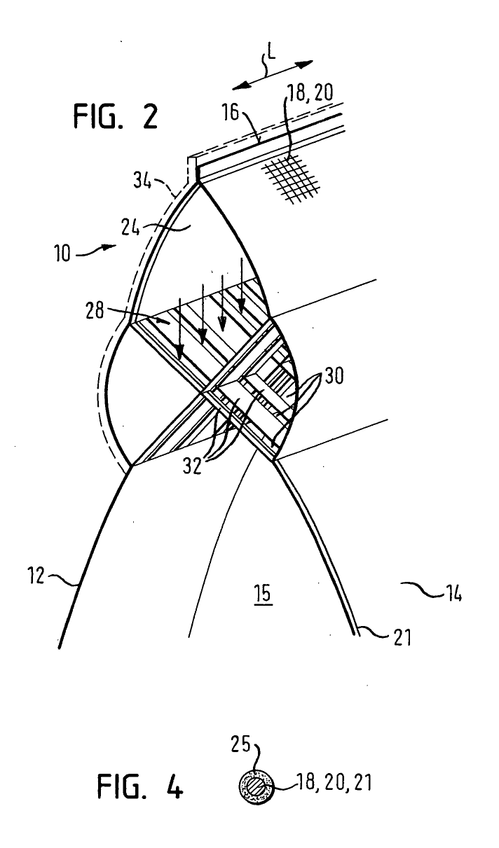

The side gas bag 10 has a first side wall 12 and a second side wall 14. The side walls 12, 14 at least partially delimit several inflatable chambers 15, only one of which is shown. The side walls 12 and 14 consist of a woven fabric which contains warp threads 18 and weft threads 20, as indicated in FIGS. 1 and 2. Additionally, pile threads 21 can be provided (FIG. 3). On an upper edge 16, which forms one of the longitudinal sides of the side gas bag 10, the side walls 12, 14 are interwoven with each other. In an installed state in the vehicle, the gas bag could be fastened in the region of the edge 16 for example to a roof frame.

A short distance beneath the edge 16, the two side walls 12, 14 are connected with each other by two dividing walls 22. Both dividing walls 22 run over a predetermined length t freely through the interior of the side gas bag 10 between the side walls 12, 14. The dividing walls 22 are formed by warp and/or weft threads 18, 20 of one of the two side walls or supplementary thereto or exclusively by additional pile threads 21. Pile threads are additional threads in the woven fabric of one or both side walls 12, 14 which are entrained in a floating manner (indicated in FIG. 3).

With the formation of a dividing wall 22, the warp, weft and/or pile threads 21 leave the woven fabric composite of the respective side wall 12, 14 and run over a predetermined length t freely in the interior of the side gas bag 10 until they enter into the woven fabric composite of the other side wall 14, 12.

The threads forming the dividing walls 22 emerge from the woven fabric composite of one side wall, assuming for example the first side wall 12, are interwoven with each other again outside the side wall 12 and run for a distance freely through the interior of the gas bag 10 and enter in to the woven fabric composite of the other side wall, in this case the second side wall 14. The threads forming the dividing walls 22 can also run without interweaving from one side wall 12, 14 through the gas bag 10 to the other side wall 14, 12.

The preferred thread density of the dividing wall 22 outside the overflow section 28 amounts to approximately half to two thirds the thread density of the side walls 12, 14. With a conventional thread density of 235 thread/dm for gas bag woven fabric, this therefore corresponds to 120 to 180 thread/dm.

The dividing walls 22 extend at least over a majority of the longitudinal extent in the direction L of the side gas bag 10. Between the upper edge 16 and the dividing walls 22, a gas duct 24 is formed. As indicated in FIG. 1, this gas duct 24 is in direct flow connection with a gas generator 26 which delivers the necessary gas for inflating the side gas bag 10.

In the region of each inflatable chamber 15, the dividing wall 22 has at least one overflow section 28. Such an overflow section 28 is shown in FIG. 2. In the region of the overflow section 28, the gas permeability of the dividing wall 22 is distinctly greater than in its remaining region. Hereby, in the overflow section 28 the gas can flow from the gas duct 24, as indicated by the arrows, into the inflatable chamber 15. Through the high gas-tightness of the dividing wall 22 in the remaining region, an overflowing of the gas into the inflatable chambers 15 outside the overflow section or sections 28 is largely prevented.

The gas-permeability of the overflow sections 28 can be achieved in that the dividing walls 22 have gaps 30, as in the example shown. In this example, between the gaps 30 lie webs 32 which have the same gas-tightness as the remainder of the dividing wall 22.

It would also be possible to reduce the thread density of the dividing wall 22 uniformly in the entire region of the overflow section 28 and so to achieve a higher gas-permeability.

In the variant shown in FIG. 3, four dividing walls 22 are provided, which delimit a gas duct 24′ which is diamond-shaped in cross-section. The gas flows principally through the gas duct 24′, but provision can also be made that gas also flows through the sections of the side gas bag 10 lying between the dividing walls 22 and the edge 16, running parallel to the gas duct 24′.

In order to increase the gas-tightness of the dividing walls 22 outside the overflow sections 28, preferably a coating 25 of the dividing walls 22 or of the threads forming the dividing walls 22 is provided. The coating 25 can, for example, be done by silicon dissolved in water. Such a coating additionally serves as a protection against the thermal stress by the hot gas stream.

If only warp and/or weft threads of the side walls 12, 14 are used for forming the dividing wall 22, only a support structure remains of the side wall woven fabrics in the region of the gas duct 24. If additional pile threads 21 are used in order to form the dividing walls 22, the thread density of the side walls 12, 14 can also remain unchanged in the region of the gas duct 24. Embodiments which lie between these extremes are also conceivable.

In the region of the gas duct 24, the side walls 12, 14 can be additionally sealed by woven fabric layers. This is shown diagrammatically in FIG. 2 by reference number 34 on the side of the first side wall 12.

In an embodiment of the invention, the two side walls 12, 14 are continued beyond the upper edge 16 and are respectively turned over to the side in order to cover the side gas bag 10 in the region of the gas duct 24 and to thus provide for a higher gas-tightness. In this case, the woven fabric layer 34 is formed by a woven fabric section constructed in one piece with the side wall 12, which is connected with the first side wall 12 for example by glueing. An analogous construction is provided in the region of the second side wall 14.

The sealing of the first and second side wall 12, 14 in the region of the dividing walls 22 and of the gas duct 24 can also take place by a coating.

For geometric reasons, preferably an even number of dividing walls 22 are provided, with precisely as many threads running from the first side wall 12 to the second side wall 14 as threads from the second side wall 14 to the first side wall 12. This applies in particular when the dividing walls 22 consist at least for the majority of warp and/or weft threads 18, 20 of the two side walls 12, 14.

1. A gas bag, in particular a side gas bag for a vehicle occupant restraint system,
with a first and a second planar side wall (12, 14), connected with each other, consisting of a textile fabric with warp threads (18) and weft threads (20), which at least partially laterally delimit at least one inflatable chamber (15),
at least one elongated dividing wall (22) being provided between the side walls (12, 14), the dividing wall (22) running continuously over a majority of a length (L) of the side gas bag (10) and delimiting a gas duct (24; 24′) directing inflowing gas into the inflatable chamber (15),
the dividing wall (22) being formed by threads leaving a textile fabric composite of one of the side walls (12, 14) in a direction of the opposite side wall (14, 12) and run over a predetermined length (t) in an interior of the side gas bag (10), and
the dividing wall (22) having at least one overflow section (28) with a higher gas-permeability than that of the remaining dividing wall (22), which forms a flow path from the gas duct (24; 24′) to an adjoining inflatable chamber (15).

2. The gas bag according to claim 1, wherein the dividing wall (22) is constructed so as to be largely gas-tight outside the overflow section (28).

3. The gas bag according to claim 1, wherein the dividing wall (22) is provided with a coating (25).

4. The gas bag according to claim 1, wherein the threads forming the dividing wall (22) are provided with a coating (25).

5. The gas bag according to claim 1, wherein the overflow section (28) has a lower thread density than the remaining dividing wall (22).

6. The gas bag according to claim 1, wherein in the overflow section (28) the dividing wall (22) has at least one gap (30).

7. The gas bag according to claim 1, wherein for the formation of the dividing wall (22) at least one of warp threads (18), weft threads (20) and pile threads (21) of the first side wall (12) emerge from the textile fabric composite of the first side wall (12), run to the second side wall (14) and enter into the textile fabric composite of the second side wall (14).

8. The gas bag according to claim 1, wherein two dividing walls (22) are provided which, viewed in cross-section, form the shape of an X.

9. The gas bag according to claim 1, wherein four dividing walls (22) are provided, which delimit a gas duct (24′) which is diamond-shaped in cross-section.

10. The gas bag according to claim 1, wherein the gas duct (24; 24′) runs in the immediate vicinity of and parallel to an upper edge (16) of the side gas bag (10).

11. The gas bag according to claim 1, wherein the gas duct (24; 24′) is in direct flow connection with a gas generator (26).
